(19) United States
(12) Patent Application Publication
(10) Pub. No.: US 2026/0292962 A1
(43) Pub. Date: Sep. 24, 2026

(54) DECORATIVE DEVICE, CONTROL CIRCUIT, AND CONTROL METHOD

(71) Applicant: Fan Zhang, Taizhou (CN)

(72) Inventor: Fan Zhang, Taizhou (CN)

(21) Appl. No.: 19/428,271

(22) Filed: Dec. 21, 2025

Related U.S. Application Data
(63) Continuation of application No. 19/086,372, filed on Mar. 21, 2025.

(51) Int. Cl. H05B 47/175; F21V 23/06; G06F 3/16; G10L 15/22; H04R 1/02; H04R 3/00; H05B 47/12; F21W 121/00

(52) U.S. Cl. CPC H05B 47/197; F21V 23/06; G06F 3/162; G06F 3/165; G10L 15/22; H04R 1/028; H04R 3/00; H05B 47/12; F21W 2121/00; G10L 2015/223

(57) ABSTRACT

A decorative device includes a host-controlling device, a decoration, a slave-controlling device, and a mounting structure. The decoration includes a first connection portion. The slave-controlling device is fixed to the decoration and includes a first port, a speaker, and a string light, with the speaker and string light electrically connected to the first port. The mounting structure is installed on an object to be decorated and includes a second connection portion and a second port, selectively electrically connected to the first port. The host-controlling device is electrically connected to the second port. The first connection portion is detachably connected to the second connection portion, allowing the decoration to be detachably connected to the mounting structure. The first and second ports are fixed to the first and second connection portions, respectively, and electrically connected when the decoration is installed.

### TECHNICAL FIELD

This application relates to decoration field, and specifically relates to a decorative device, a control circuit, and a control method.

### BACKGROUND OF THE INVENTION

A fixed installation structure is usually adopted for existing decorative equipment. When it is necessary to adjust the decorative style according to the needs of holiday changes, theme updates, etc., it is often required to dismantle and replace the entire decorative system, which makes it impossible to reuse the original facilities, resulting in a waste of resources and an increase in costs. Especially for decorative equipment containing electrical components, its disassembly and reinstallation process is complicated, with wiring difficulties, interface mismatch, and other problems seriously affecting the convenience of use. In addition, the electrical connection part and the mechanical connection part of traditional decorative equipment usually adopt a separate design, which requires separate mechanical fixing and electrical connection operations in the installation process, which not only increases the difficulty of installation but also quickly leads to poor contact and other potential safety hazards. Therefore, there is an urgent need for a decorative device that can be rapidly disassembled and reused and has reliable electrical connections to meet the decorative needs of different scenarios.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a decorative device is provided, comprising:

a host-controlling device;

a decoration including a first connection portion;

a slave-controlling device fixed to the decoration, the slave-controlling device including a first port, a speaker, and a string light, wherein the speaker and the string light are electrically connected to the first port;

a mounting structure installed on an object to be decorated, the mounting structure including a second connection portion and a second port, wherein the second port is selectively electrically connected to the first port, and the host-controlling device is electrically connected to the second port;

wherein the first connection portion is detachably connected to the second connection portion to allow the decoration to be detachably connected to the mounting structure, the first port is fixed to the first connection portion, the second port is fixed to the second connection portion corresponding to the first port, and when the decoration is installed on the mounting structure through the first connection portion and the second connection portion, the first port is electrically connected to the second port.

In another aspect, a control circuit for a decorative device is provided, applied to a decorative device, the decorative device comprising:

a host-controlling device;

a decoration including a first connection portion;

a slave-controlling device fixed to the decoration, the slave-controlling device including a first port, a speaker, and a string light, wherein the speaker and the string light are electrically connected to the first port;

a mounting structure installed on an object to be decorated, the mounting structure including a second connection portion and a second port, wherein the second port is selectively electrically connected to the first port, and the host-controlling device is electrically connected to the second port;

wherein the first connection portion is detachably connected to the second connection portion to allow the decoration to be detachably connected to the mounting structure, the first port is fixed to the first connection portion, the second port is fixed to the second connection portion and corresponds to the first port, and when the decoration is installed on the mounting structure through the first connection portion and the second connection portion, the first port is electrically connected to the second port;

the control circuit comprises:

a host controller;

a microcontroller, a speaker, and a string light, wherein the microcontroller is configured to generate a second control signal, the speaker is electrically connected to the microcontroller, the string light is electrically connected to the host controller or the microcontroller, and the host controller is selectively electrically connected to the microcontroller;

a sensor electrically connected to the host controller, the sensor is configured to output first information to the host controller;

when the host controller is electrically connected to the microcontroller, the host controller controls the speaker to produce sound and/or the string light to emit light based on the first information.

In another aspect, a control method for a decorative device is provided, applied to a decorative device, the decorative device comprising:

a host-controlling device;

a decoration including a first connection portion;

a slave-controlling device fixed to the decoration, the slave-controlling device including a first port, a speaker, and a string light, wherein the speaker and the string light are electrically connected to the first port;

a mounting structure installed on an object to be decorated, the mounting structure including a second connection portion and a second port, wherein the second port is selectively electrically connected to the first port, and the host-controlling device is electrically connected to the second port;

wherein the first connection portion is detachably connected to the second connection portion to allow the decoration to be detachably connected to the mounting structure, the first port is fixed to the first connection portion, the second port is fixed to the second connection portion and corresponds to the first port, and when the decoration is installed on the mounting structure through the first connection portion and the second connection portion, the first port is electrically connected to the second port;

the control method comprising:

obtaining first information by the host-controlling device, the first information obtained based on detecting biological activity;

controlling the speaker to produce sound and/or the string light to emit light by the host-controlling device based on the first information.

The above aspects or examples and advantages, as well as other aspects or examples and advantages, will become apparent from the ensuing description and accompanying drawings.

### BRIEF DESCRIPTION OF DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is a schematic block diagram of the structure of a decorative device provided by an embodiment of the present application;

FIG. 2 is a schematic block diagram of the structure of a host-controlling device provided by an embodiment of the present application;

FIG. 3 is a schematic block diagram of the structure of a host controller provided by an embodiment of the present application;

FIG. 4 is a schematic block diagram of the structure of a slave-controlling device provided by an embodiment of the present application;

FIG. 5 is a schematic view of the structure of a decoration provided by an embodiment of the present application;

FIG. 6 is another schematic view of the structure of a decoration provided by an embodiment of the present application;

FIG. 7 is yet another schematic view of the structure of a decoration provided by an embodiment of the present application;

FIG. 8 is a schematic layout view of a decoration provided by an embodiment of the present application;

FIG. 9 is another schematic layout view of a decoration provided by an embodiment of the present application;

FIG. 10 is another schematic layout view of a decoration provided by an embodiment of the present application;

FIG. 11 is an exploded view of the structure of a decoration and a mounting structure provided by an embodiment of the present application;

FIG. 12 is another exploded view of the structure of a decoration and a mounting structure provided by an embodiment of the present application;

FIG. 13 is another exploded view of the structure of a decoration and a mounting structure provided by an embodiment of the present application;

FIG. 14 is another exploded view of the structure of a decoration and a mounting structure provided by an embodiment of the present application;

FIG. 15 is another exploded view of the structure of a decoration and a mounting structure provided by an embodiment of the present application;

FIG. 16 is a schematic circuit diagram of a decorative device provided by an embodiment of this application;

FIG. 17 is a schematic flow diagram of a control method for a decorative device provided by an embodiment of the present application; and

FIG. 18 is another schematic flow diagram of a control method for a decorative device provided by an embodiment of the present application.

Reference Number: decoration-controlling device—1; host-controlling device—2; host controller—3; processor—4; communication Bus Wire—5; memory—6; communication Interface—7; first communication module—8; RF receiving module—9; WIFI module—10; first power—11; slave-controlling device—12; microcontroller—13; audio-decoding module—14; second communication module—15; amplifier—16; speaker—17; microphone—18; second power module—19; string light—20; protection resistor—21; NPN transistor—22; LED string light—23; first port—24; contact—25; wire—26; decoration—27; connection portion—28; plug—29; hanging hole—30; first magnet—31; threaded column—32; mounting structure—33; second connection portion—34; slot—35; rope—36; second magnet—37; threaded hole—38; second port—39; sensor—40; user interface—41; voice identification Module—42; button—43; remote controller—44; smart device—45; contact plate—46; capacitor—47.

### DETAILED DESCRIPTION OF THE INVENTION

The present disclosure will be further described in detail below with reference to the drawings. A preferred embodiment is described in the drawings. However, the present disclosure can be implemented in many different forms and is not limited to the embodiments described herein. Rather, these embodiments are provided to provide a thorough understanding of the present disclosure. The specific embodiments are only explanations of the present disclosure, and the embodiments are not intended to limit the present disclosure. Rather, various modifications may be made in the details within the scope and range of equivalents of the claims and without departing from the present disclosure.

The present disclosure will be described in more details below with reference to the accompanying drawings and in conjunction with embodiments. The examples are provided for better illustration of the present disclosure and should not limit the scope of the present disclosure. In practice, technicians skilled in the art might make small modifications and/or variations of the present disclosure without departing from the scope or spirit of the present disclosure. For example, features described in part of one embodiment may be used in another to create a new embodiment. It is therefore desirable that the present disclosure encompass such modifications and/or variations falling within the scope of the appended claims and their equivalents.

In the description of the present disclosure, terms like “longitudinal”, “transverse”, “up”, “down”, “front”, “back”, “left”, “right”, “vertical”, “horizontal”, “top”, “bottom” denote orientation or positional relationships based on those shown in the drawings and are intended for ease of description only, which in no way entails that the present disclosure must be constructed and operated in a particular orientation and therefore cannot be construed as limiting to the present disclosure. Terms like “joint”, “attach” and “set” used in the present disclosure should be understood in a broad sense, for example, may indicate a direct connection or indirect connection through intermediate components; and it may be a wired electrical connection, a radio connection, or a wireless communication signal connection. The exact meanings of the above terms may slightly differ and should be derived from the actual situation by technicians skilled in the art accordingly.

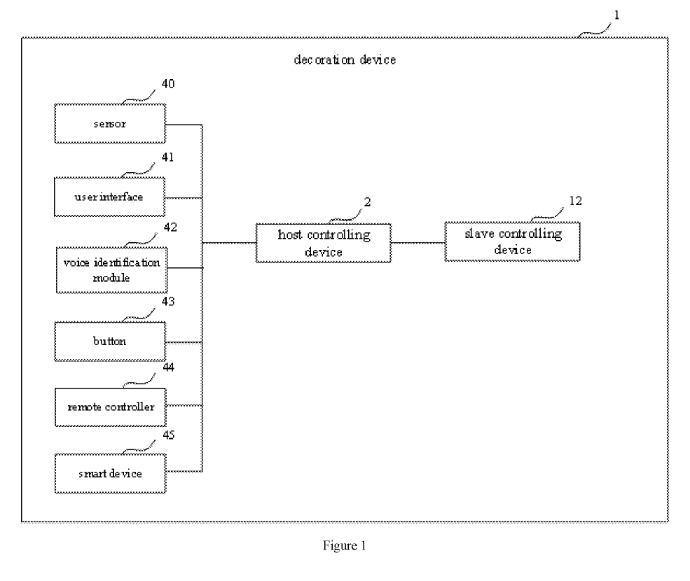

Please refer to FIG. 1, which illustrates a schematic block diagram of a decorative device provided by an embodiment of this application. The decorative device 1 includes a host-controlling device 2, a slave-controlling device 12, a decoration 27, and a mounting structure 33. Among these, the host-controlling device 2 includes at least one host controller 3, a first communication module 8, a microphone 18, a third port, and a first power module 11. Each device and module will be introduced in detail below.

### Host-Controlling Device

The host-controlling device 2 is primarily used for sending control instructions and controlling the operation of other devices or modules based on these instructions.

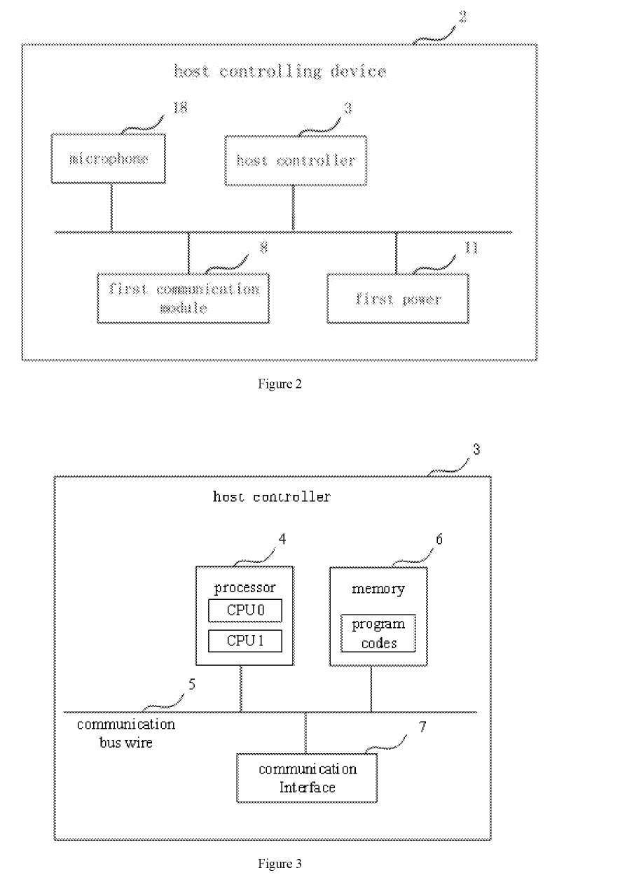

As shown in FIG. 2, the host controller 3, the first communication module 8, the microphone 18, and the first power module 11 are interconnected.

### Host Controller

As shown in FIG. 3, the host controller 3 includes at least one processor 4, a communication bus 5, a memory 6, and at least one communication interface 7.

Among these, the processor 4, the memory 6, and the communication interface 7 communicate through the communication bus 5 or through other means such as wireless transmission. The memory 6 is used for storing instructions, and the processor 4 is used for executing the instructions stored in the memory 6. Memory 6 stores the program code, and processor 4 calls the program code stored in memory 6 to execute the methods provided by this application.

Optionally, processor 4 is a general-purpose central processing unit (CPU), or it can be another general-purpose processor, a digital signal processor (DSP), an application-specific integrated circuit (ASIC), a field-programmable gate array (FPGA), or another programmable logic device (PLD), transistor logic device, hardware component, or any combination thereof. The PLD mentioned above can be a complex programmable logic device (CPLD), a field-programmable gate array (FPGA), a generic array logic (GAL), or any combination thereof.

The communication bus 5 is used for transmitting information between the processor 4, the memory 6, and the communication interface 7. The communication bus 5 is divided into an address bus, a data bus, and a control bus. For simplicity, only one thick line is shown in the figure, but this does not mean there is only one bus or one type of bus.

Memory 6 is mainly used for storing audio files, configuration data, log information, cache data, etc. In this embodiment, the memory 6 can use a Micro SD card, which not only has a large capacity (GB level) and is easy to expand but also has fast read and write speeds, making it suitable for storing audio and other files. In some embodiments, the second storage module can also use SPI Flash memory, EEPROM memory, eMMC memory, etc., but is not limited to these.

Optionally, memory 6 is a read-only memory (ROM) or another type of static storage device that can store static information and instructions. Alternatively, memory 6 is a random access memory (RAM) or another type of dynamic storage device that can store information and instructions. Alternatively, the memory 6 is an electrically erasable programmable read-only memory (EEPROM), a compact disc read-only memory (CD-ROM), or another optical disc storage, disc storage (including compressed discs, laser discs, optical discs, digital versatile discs, Blu-ray discs, etc.), disk storage medium, or another magnetic storage device, or any other medium that can be used to carry or store program code in the form of instructions or data structures and can be accessed by a computer but is not limited to these. Optionally, the memory 6 exists independently and is connected to the processor 4 through the communication bus 5. Optionally, the memory 6 and the processor 4 are integrated together.

The host-controlling device 2 also includes memory 6, which is mainly used for storing system programs, user data, audio files, and other information. In this embodiment, memory 6 is the RAM (running memory) and ROM (storage memory) of a mobile phone. In some embodiments, the memory 6 can also be NOR Flash memory, eMMC memory, EEPROM memory, Micro SD card, SPI Flash memory, etc., but is not limited to these.

The communication interface 7 uses any transceiver-like device for communicating with other devices or communication networks. The communication interface 7 includes a wired communication interface. Optionally, the communication interface 7 also includes a wireless communication interface. Among these, the wired communication interface can be an Ethernet interface. The Ethernet interface can be an optical interface, an electrical interface, or a combination thereof. The wireless communication interface can be a wireless local area network (WLAN) interface, a cellular network communication interface, or a combination thereof.

In specific implementations, as one embodiment, the processor 4 includes one or more CPUs.

In specific implementations, as one embodiment, the host controller 3 includes multiple processors 4. Each of these processors 4 is a single-core processor (single-CPU) or a multi-core processor (multi-CPU). Here, processor 4 refers to one or more devices, circuits, and/or processing cores for processing data (such as computer program instructions).

In some embodiments, memory 6 is used for storing program code for executing the solution of this application, and processor 4 executes the program code stored in memory 6.

### First Communication Module

The first communication module 8 is used for communication between external devices and the host-controlling device 2. The host-controlling device 2 receives signals from external devices through the first communication module 8.

In this embodiment, the first communication module 8 is a wireless communication module, and the first communication module 8 includes a WIFI module 10 and an RF receiving module 9.

In some embodiments, the first communication module 8 also includes Bluetooth, infrared communication modules, and microwave communication modules.

In some embodiments, the first communication module 8 is a wired communication module.

### First Power Module

The first power module 11 is mainly used for powering the host-controlling device 2.

In this embodiment, the first power module 11 includes a battery and a charging circuit module, which are mainly used for powering the circuit components of the host-controlling device.

In some embodiments, the host-controlling device 2 can also be powered by an external power source; for example, the first power module 11 can use USB charging, and the host-controlling device 2 can be powered by an external power source.

### Third Port

The third port is a threaded electrical connector, which achieves a firm connection through threaded tightening.

In some embodiments, the third port can use plug-in electrical connectors, magnetic electrical connectors, spring pin connectors, snap connectors, USB Type-C ports, Micro USB ports, etc., but is not limited to these.

### Microphone

The microphone 18 is mainly used for sensing sound signals and interacting with voice commands. In some embodiments, the microphone 18 can use an INMP441 microphone. In some embodiments, the microphone 18 can also use digital microphones such as PDM microphones, I2S microphones, etc., array microphones such as MEMS microphone arrays, digital microphone arrays, etc., but is not limited to these.

### Slave-Controlling Device

The slave-controlling device 12 is fixed to the decoration 27. As shown in FIG. 4, the slave-controlling device 12 includes a microcontroller 13, an audio-decoding module 14, a second communication module 15, an amplifier 16, a speaker 17, a second power module 19, a string light 20, and a first port 24. The speaker 17 and the string light 20 are electrically connected to the first port 24. The slave-controlling device 12 is fixed to the decoration 27.

In some embodiments, the slave-controlling device 12 is part of the decoration 27 and is used for receiving and executing control instructions from the host-controlling device 2.

### Microcontroller

Microcontroller 13 is mainly used for data processing, communication control, light control, audio playback, volume control, etc. The composition of the microcontroller 13 is similar to that of the host controller 3, and the specific structure can be referred to as shown in FIG. 3, which will not be repeated here.

### Audio-Decoding Module

The audio-decoding module 14 is mainly used for audio format decoding, digital signal processing, and analog signal output.

In this embodiment, the audio-decoding module 14 uses a VS1053 module, which supports multiple audio formats such as MP3, WAV, AAC, etc., has a built-in stereo DAC with a signal-to-noise ratio of ≥90 dB, supports I2S output, and can be directly connected to the amplifier module 16. In some embodiments, the audio-decoding module 14 can also use DF Player Mini modules, WM8960 modules, PCM5102 modules, etc., but is not limited to these.

### Second Communication Module

The second communication module 15 is used for communication between the host-controlling device 2 and the slave-controlling device 12. The slave-controlling device 12 receives signals from the host-controlling device 2 or other devices through the second communication module 15.

In this embodiment, the second communication module 15 is a wired communication module.

In some embodiments, the second communication module 15 is a wireless communication module, and the second communication module 15 uses communication methods such as WI-FI, Bluetooth, infrared, RF, and microwave.

### Amplifier

The amplifier 16 is mainly used for amplifying the low-power audio signals output by the audio-decoding module 14 to drive the speaker 17 to play sound. In this embodiment, the amplifier 16 uses a PAM8403 audio amplifier, which does not require an external low-pass filter, has the characteristics of low cost, low voltage compatibility, and high integration, and is very suitable for small devices that are sensitive to size and power consumption. In some embodiments, the amplifier 16 can also use LM4890 audio amplifiers, LM4871 audio amplifiers, XS8302 audio amplifiers, LTK5156 audio amplifiers, or HAA2820E audio amplifiers, etc., but is not limited to these.

### Speaker

Speaker 17 is mainly used for receiving instructions from the host-controlling device 2, decoding, and playing theme music or sound effects in MP3/WAV formats. In this embodiment, the speaker 17 uses a 452/3 W speaker. In some embodiments, to balance human voice and background music, a full-range speaker 17 can be used. In some embodiments, to extend the service life of the speaker 17 in outdoor use, a speaker 17 with IP65 protection level, dustproof and waterproof, can be used.

### Second Power Module

The second power module 19 is used for seamlessly switching power supply when the external power supply is insufficient or fails, avoiding the disappearance of light effects and interruption of audio playback. In this embodiment, the second power module 19 can use rechargeable batteries.

### String Light

The string light 20 is mainly used for creating atmosphere and enhancing visual effects, and for scene decoration to enhance the immersion of the festival. In this embodiment, the string light 20 is model 3528, including positive and negative terminals. In some embodiments, the string light 20 can also use models 5050, 2835, 3014, or 5630, as well as smart Bluetooth/Wi-Fi, color string lights, programmable string lights, waterproof string lights, electronic candles, starry sky projection lights, LED string lights, RGB string lights, etc., but is not limited to these.

### Mounting Structure

The mounting structure 33 is installed on the object to be decorated. The mounting structure 33 includes a second connection portion 34 and a second port 39. The second port 39 is selectively electrically connected to the first port 24. The first connection portion 28 is detachably connected to the second connection portion 34 to allow the decoration 27 to be detachably connected to the mounting structure 33. The first port 24 is fixed to the first connection portion 28, and the second port 39 is fixed to the second connection portion 34 and corresponds to the first port 24. When the decoration 27 is installed on the mounting structure 33 through the first connection portion 28 and the second connection portion 34, the first port 24 is electrically connected to the second port 39.

### Decoration

The decoration 27 is the core component of festival decoration, creating an immersive festival atmosphere through the combination of sound effects, light effects, and dynamic effects. The decoration 27 includes a first connection portion 28.

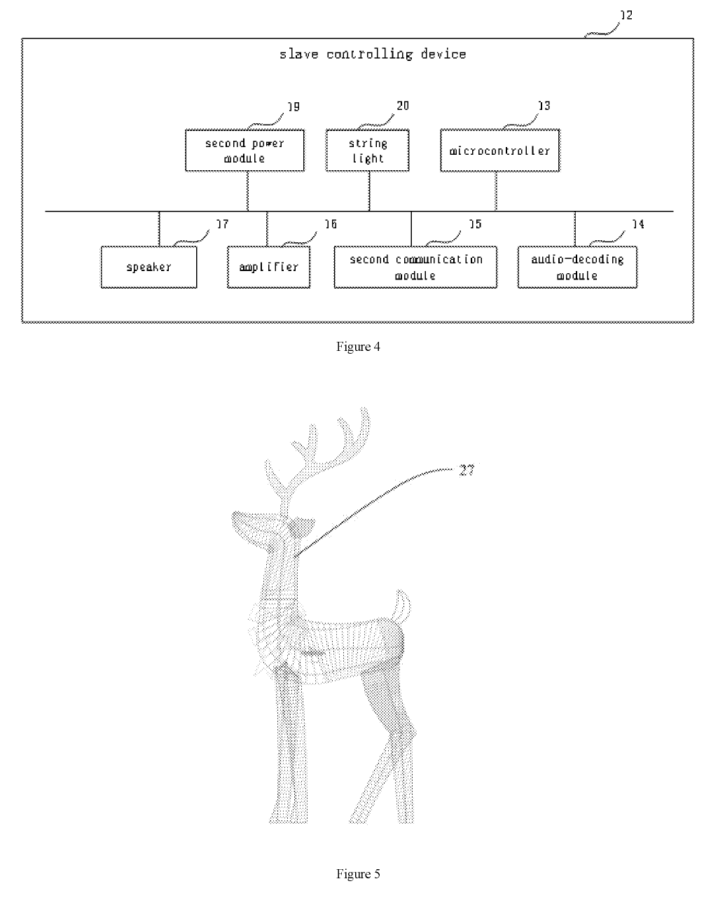

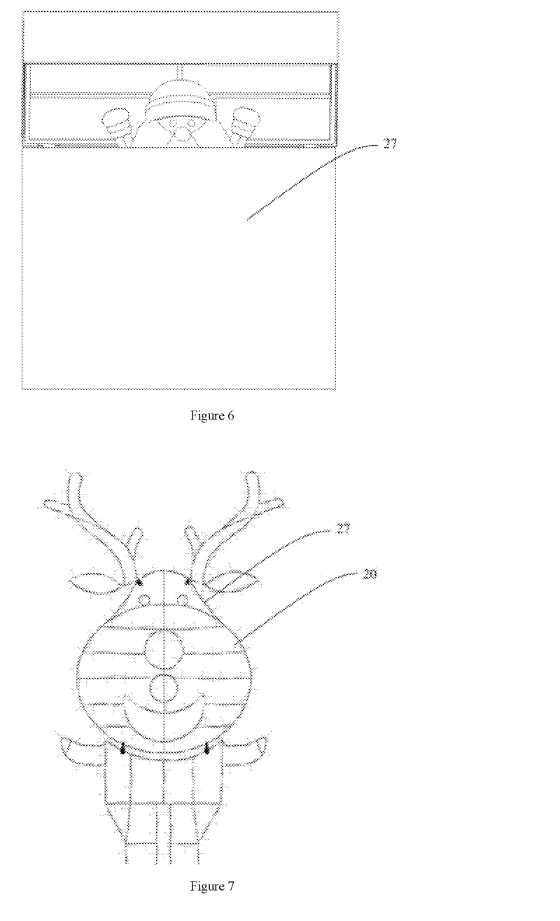

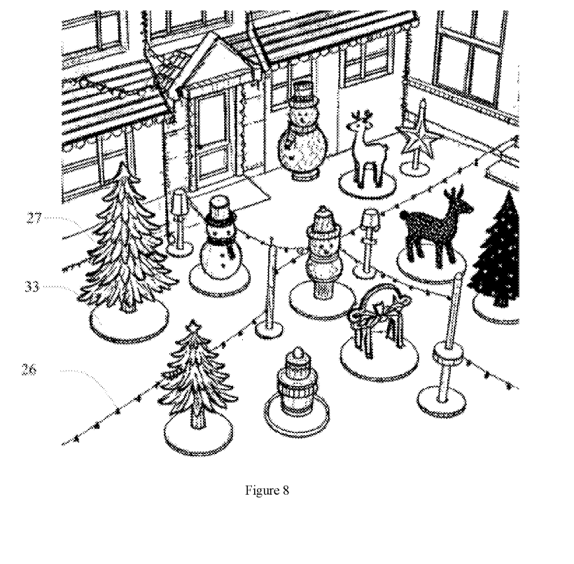

As shown in FIGS. 5-10, in this embodiment, the decoration 27 includes Santa Claus, 3D reindeer, cartoon reindeer, snowmen, Christmas trees, gift boxes, candy cane lights, pumpkin lights, ghosts, bats, skeletons, black cats, etc. These decorations 27 have matching dynamic light effects, sound effects, and dynamic effects. The mounting structure 33 is installed on the object to be decorated, the decoration 27 is detachably connected to the mounting structure 33, and the slave-controlling device 12 is fixed to the decoration 27.

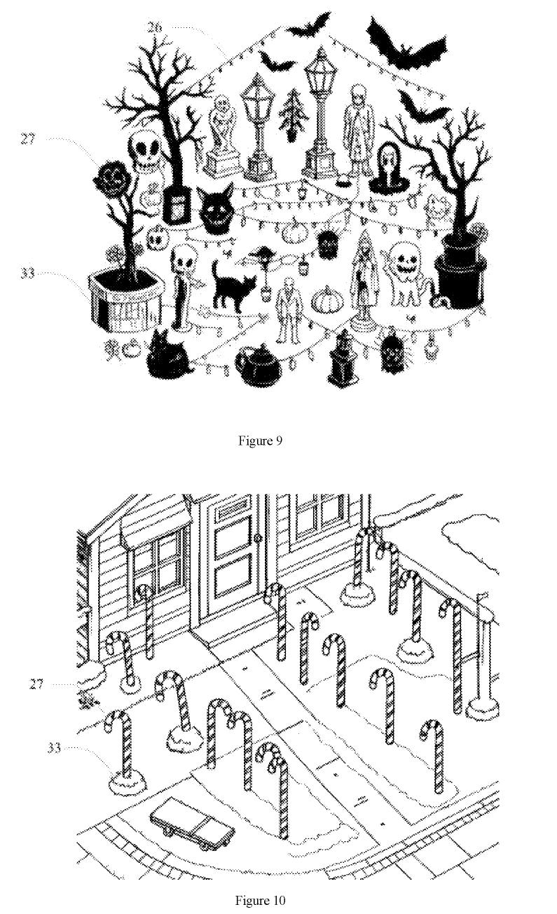

As shown in FIGS. 8-9, in this embodiment, the slave-controlling device 12 is connected to the host-controlling device 2 through a wire 26.

As shown in FIG. 10, in some embodiments, the slave-controlling device 12 is connected to the host-controlling device 2 wirelessly.

### Sensor

The sensor 40 is mainly used for detecting biological activity and transmitting the detected information to the host-controlling device 2. The sensor 40 is electrically connected to the host-controlling device 2. For example, when a human enters the detection range of sensor 40, sensor 40 generates first information based on the detected signal and sends it to the host controller 3 of the host-controlling device 2 so that the host controller 2 triggers light effects and/or plays voice or music based on the first information.

In this embodiment, sensor 40 is installed on decoration 27 to enhance the interaction between decoration 27 and biological entities (such as humans).

### User Interface

The user interface 41 is mainly used for user input and status display.

In this embodiment, the user interface 41 includes a touch screen, and users can manage devices (add, delete, group), manage audio files (upload, delete, play), control playback (play, pause, volume adjustment), and display status (battery level, playback progress) through the touch screen.

### Voice Identification Module

The voice identification module 42 is mainly used for interacting with voice commands. In some embodiments, the voice identification module 42 uses the LD3320 offline voice recognition module. The LD3320 is a single-chip module that supports offline non-specific voice recognition, can dynamically edit up to 50 keywords, does not require networking or user voice training, has a recognition response time of ≤500 ms, and an accuracy rate of ≥95% in a quiet environment.

### Button

The button 43 is configured to control the host controller 3 to output signals of different states. Short press, long press, double-click, and release of button 43 correspond to different signals so that the host controller 3 generates different control instructions. Among these, different control instructions correspond to different light modes and audio playback.

### Remote Controller

The remote controller 44 is used to remotely control the sound and light effects of the holiday decorations through wireless signals (such as infrared, Bluetooth, RF, microwave, or Wi-Fi), supporting functions such as play, pause, volume adjustment, and light effect switching.

In this embodiment, the remote controller 44 uses a low-power Bluetooth remote controller (such as the nRF52832 remote controller), which has strong compatibility, low power consumption, and is easy to integrate with mobile phone apps. In some embodiments, the remote controller 44 can use infrared remote controllers (infrared emission modules based on the NEC protocol) or Wi-Fi remote controllers (based on ESP32).

### Smart Device

The smart device 45 is used to receive instructions input by the user and transmit these instructions to the host controller 3.

In this embodiment, the smart device 45 includes mobile phones, computers, etc.

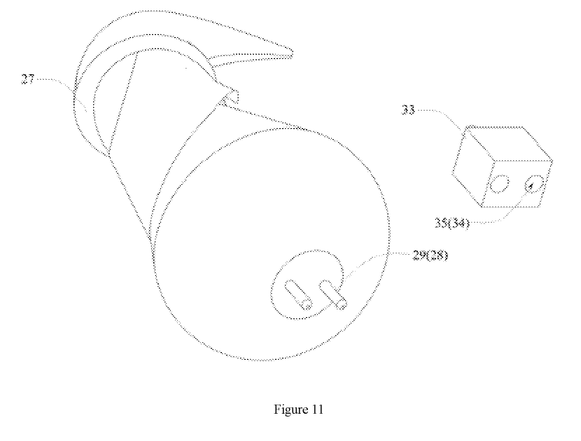

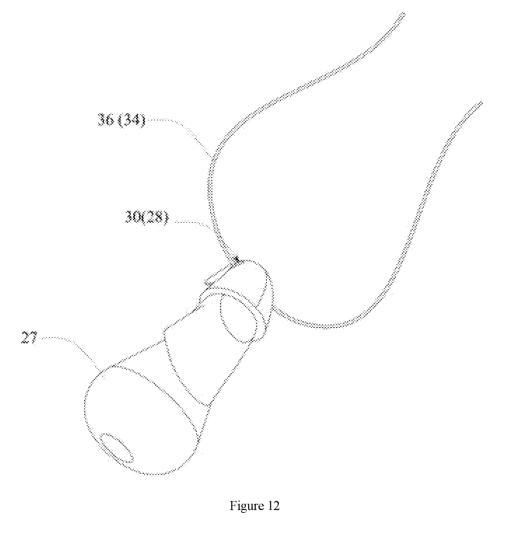

The connection structure of the decorative device 1 will be introduced below in conjunction with FIGS. 11-15.

In this embodiment, as shown in FIG. 11, the detachable connection is achieved by plugging, and the first connection portion 28 and the second connection portion 34 are a plug 29 and a slot 35, respectively.

In one embodiment, as shown in FIG. 12, the detachable connection is achieved by hanging, and the first connection portion 28 and the second connection portion 34 are a hanging hole 30 and a rope 36, respectively.

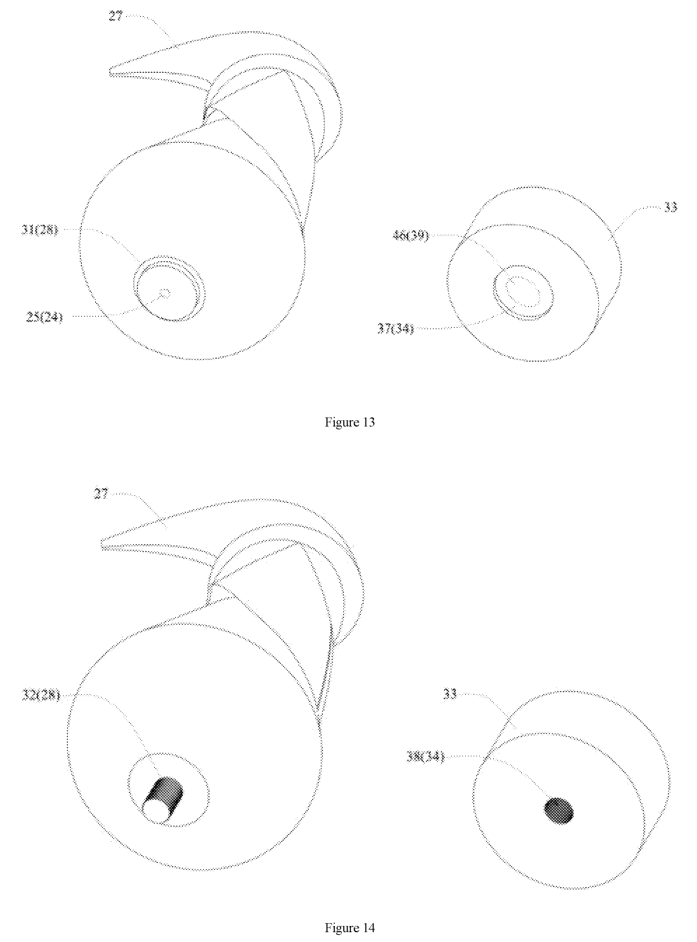

In another embodiment, as shown in FIG. 13, the detachable connection is achieved by magnetic attraction, and the first connection portion 28 and the second connection portion 34 are a first magnet 31 and a second magnet 37, respectively.

In another embodiment, as shown in FIG. 14, the detachable connection is achieved by threading, and the first connection portion 28 and the second connection portion 34 are a threaded column 32 and a threaded hole 38, respectively.

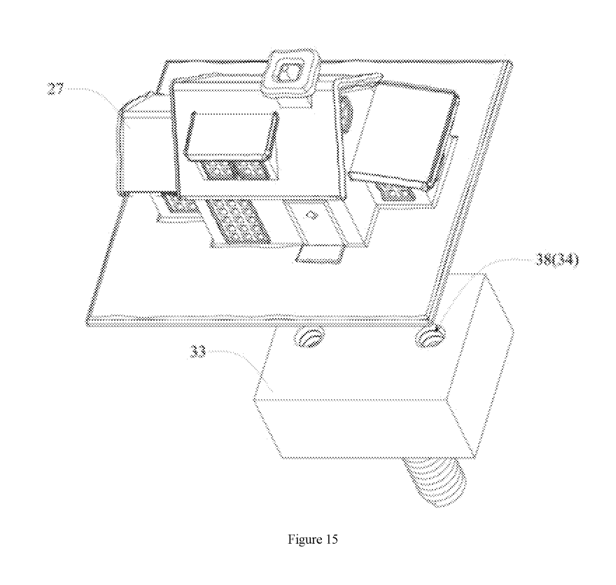

In another embodiment, as shown in FIG. 15, the detachable connection is achieved by threading, and the first connection portion (not shown in the figure) and the second connection portion 34 are a threaded column (not shown in the figure) and a threaded hole 38, respectively.

In this embodiment, the host-controlling device 2 also includes a third port, which is electrically connected to the second port 39. As shown in FIG. 13, the first port 24 and the second port 39 are a contact 25 and a contact plate 46, respectively, and the contact 25 is selectively electrically connected to the contact plate 46.

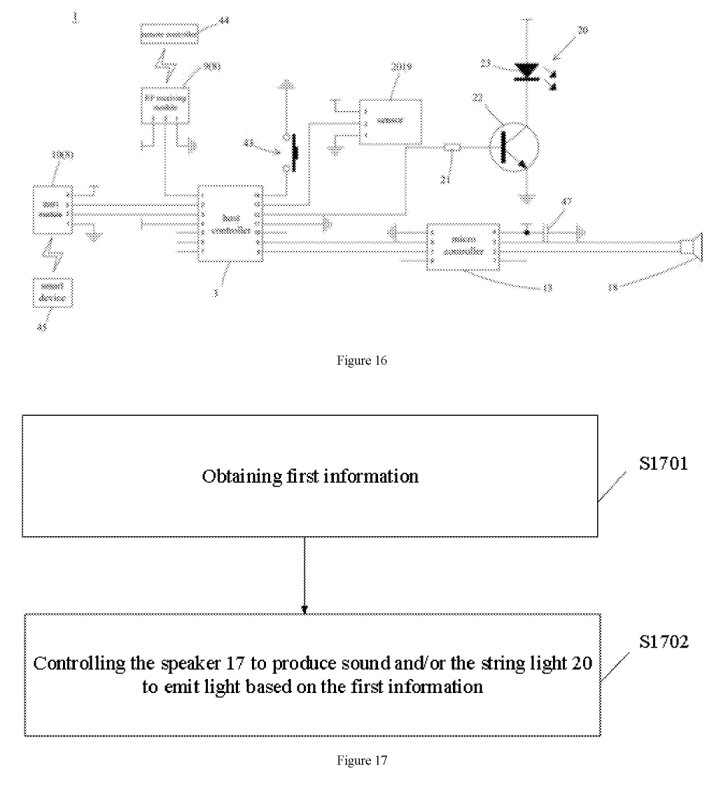

This application also provides a control circuit for the decorative device. Please refer to FIG. 16 for the circuit structure of the decorative device 1. The decorative device 1 includes: Please refer to FIG. 1, which illustrates a schematic block diagram of a decorative device provided by an embodiment of this application. The decorative device 1 includes a host-controlling device 2, a slave-controlling device 12, a decoration 27, and a mounting structure 33. Among these, the host-controlling device 2 includes at least one host controller 3, a first communication module 8, a microphone 18, a third port, and a first power module 11. Each device and module will be introduced in detail below.

### Host-Controlling Device

The host-controlling device 2 is primarily used for sending control instructions and controlling the operation of other devices or modules based on these instructions.

As shown in FIG. 2, the host controller 3, the first communication module 8, the microphone 18, and the first power module 11 are interconnected.

### Host Controller

As shown in FIG. 3, the host controller 3 includes at least one processor 4, a communication bus 5, a memory 6, and at least one communication interface 7.

Among these, the processor 4, the memory 6, and the communication interface 7 communicate through the communication bus 5 or through other means such as wireless transmission. The memory 6 is used for storing instructions, and the processor 4 is used for executing the instructions stored in the memory 6. Memory 6 stores program code and processor 4 can call the program code stored in memory 6 to execute the methods provided by this application.

Optionally, processor 4 is a general-purpose central processing unit (CPU), or it can be another general-purpose processor, a digital signal processor (DSP), an application-specific integrated circuit (ASIC), a field-programmable gate array (FPGA), or another programmable logic device (PLD), transistor logic device, hardware component, or any combination thereof. The PLD mentioned above can be a complex programmable logic device (CPLD), a field-programmable gate array (FPGA), a generic array logic (GAL), or any combination thereof.

The communication bus 5 is used for transmitting information between the processor 4, the memory 6, and the communication interface 7. The communication bus 5 is divided into an address bus, a data bus, and a control bus. For simplicity, only one thick line is shown in the figure, but this does not mean there is only one bus or one type of bus.

Memory 6 is mainly used for storing audio files, configuration data, log information, cache data, etc. In this embodiment, the memory 6 can use a Micro SD card, which not only has a large capacity (GB level) and is easy to expand but also has fast read and write speeds, making it suitable for storing audio and other files. In some embodiments, the second storage module can also use SPI Flash memory, EEPROM memory, eMMC memory, etc., but is not limited to these.

Optionally, memory 6 is a read-only memory (ROM) or another type of static storage device that can store static information and instructions. Alternatively, memory 6 is a random access memory (RAM) or another type of dynamic storage device that can store information and instructions. Alternatively, the memory 6 is an electrically erasable programmable read-only memory (EEPROM), a compact disc read-only memory (CD-ROM), or another optical disc storage, disc storage (including compressed discs, laser discs, optical discs, digital versatile discs, Blu-ray discs, etc.), disk storage medium, or another magnetic storage device, or any other medium that can be used to carry or store program code in the form of instructions or data structures and can be accessed by a computer but is not limited to these. Optionally, the memory 6 exists independently and is connected to the processor 4 through the communication bus 5. Optionally, the memory 6 and the processor 4 are integrated together.

The host-controlling device 2 also includes memory 6, which is mainly used for storing system programs, user data, audio files, and other information. In this embodiment, memory 6 is the RAM (running memory) and ROM (storage memory) of a mobile phone. In some embodiments, the memory 6 can also be NOR Flash memory, eMMC memory, EEPROM memory, Micro SD card, SPI Flash memory, etc., but is not limited to these.

The communication interface 7 uses any transceiver-like device for communicating with other devices or communication networks. The communication interface 7 includes a wired communication interface. Optionally, the communication interface 7 also includes a wireless communication interface. Among these, the wired communication interface can be an Ethernet interface. The Ethernet interface can be an optical interface, an electrical interface, or a combination thereof. The wireless communication interface can be a wireless local area network (WLAN) interface, a cellular network communication interface, or a combination thereof.

In specific implementations, as one embodiment, the processor 4 includes one or more CPUs.

In specific implementations, as one embodiment, the host controller 3 includes multiple processors 4. Each of these processors 4 is a single-core processor (single-CPU) or a multi-core processor (multi-CPU). Here, processor 4 refers to one or more devices, circuits, and/or processing cores for processing data (such as computer program instructions).

In some embodiments, memory 6 is used for storing program code for executing the solution of this application, and processor 4 executes the program code stored in memory 6.

### First Communication Module

The first communication module 8 is used for communication between external devices and the host-controlling device 2. The host-controlling device 2 receives signals from external devices through the first communication module 8.

In this embodiment, the first communication module 8 is a wireless communication module, and the first communication module 8 includes a WIFI module 10 and an RF receiving module 9.

In some embodiments, the first communication module 8 also includes Bluetooth, infrared communication modules, and microwave communication modules.

In some embodiments, the first communication module 8 is a wired communication module.

### First Power Module

The first power module 11 is mainly used for powering the host-controlling device 2.

In this embodiment, the first power module 11 includes a battery and a charging circuit module, which are mainly used for powering the circuit components of the host-controlling device.

In some embodiments, the host-controlling device 2 can also be powered by an external power source; for example, the first power module 11 can use USB charging, and the host-controlling device 2 can be powered by an external power source.

### Third Port

The third port is a threaded electrical connector, which achieves a firm connection through threaded tightening.

In some embodiments, the third port can use plug-in electrical connectors, magnetic electrical connectors, spring pin connectors, snap connectors, USB Type-C ports, Micro USB ports, etc., but is not limited to these.

### Microphone

The microphone 18 is mainly used for sensing sound signals and interacting with voice commands. In some embodiments, the microphone 18 can uase an INMP441 microphone. In some embodiments, the microphone 18 can also use digital microphones such as PDM microphones, I2S microphones, etc., array microphones such as MEMS microphone arrays, digital microphone arrays, etc., but is not limited to these.

### Slave-Controlling Device

The slave-controlling device 12 is fixed to the decoration 27. As shown in FIG. 4, the slave-controlling device 12 includes a microcontroller 13, an audio-decoding module 14, a second communication module 15, an amplifier 16, a speaker 17, a second power module 19, a string light 20, and a first port 24. The speaker 17 and the string light 20 are electrically connected to the first port 24. The slave-controlling device 12 is fixed to the decoration 27.

In some embodiments, the slave-controlling device 12 is part of the decoration 27 and is used for receiving and executing control instructions from the host-controlling device 2.

### Microcontroller

Microcontroller 13 is mainly used for data processing, communication control, light control, audio playback, volume control, etc. The composition of the microcontroller 13 is similar to that of the host controller 3, and the specific structure can be referred to as shown in FIG. 3, which will not be repeated here.

### Audio-Decoding Module

The audio-decoding module 14 is mainly used for audio format decoding, digital signal processing, and analog signal output.

In this embodiment, the audio-decoding module 14 uses a VS1053 module, which supports multiple audio formats such as MP3, WAV, AAC, etc., has a built-in stereo DAC with a signal-to-noise ratio of ≥90 dB, supports I2S output, and can be directly connected to the amplifier module 16. In some embodiments, the audio-decoding module 14 can also use DFPlayer Mini modules, WM8960 modules, PCM5102 modules, etc., but is not limited to these.

### Second Communication Module

The second communication module 15 is used for communication between the host-controlling device 2 and the slave-controlling device 12. The slave-controlling device 12 receives signals from the host-controlling device 2 or other devices through the second communication module 15.

In this embodiment, the second communication module 15 is a wired communication module.

In some embodiments, the second communication module 15 is a wireless communication module, and the second communication module 15 uses communication methods such as WI-FI, Bluetooth, infrared, RF, and microwave.

### Amplifier

The amplifier 16 is mainly used for amplifying the low-power audio signals output by the audio-decoding module 14 to drive the speaker 17 to play sound. In this embodiment, the amplifier 16 uses a PAM8403 audio amplifier, which does not require an external low-pass filter, has the characteristics of low cost, low voltage compatibility, and high integration, and is very suitable for small devices that are sensitive to size and power consumption. In some embodiments, the amplifier 16 can also use LM4890 audio amplifiers, LM4871 audio amplifiers, XS8302 audio amplifiers, LTK5156 audio amplifiers, or HAA2820E audio amplifiers, etc., but is not limited to these.

### Speaker

Speaker 17 is mainly used for receiving instructions from the host-controlling device 2, decoding, and playing theme music or sound effects in MP3/WAV formats. In this embodiment, the speaker 17 uses a 402/3 W speaker. In some embodiments, to balance human voice and background music, a full-range speaker 17 can be used. In some embodiments, to extend the service life of the speaker 17 in outdoor use, a speaker 17 with IP65 protection level, dustproof and waterproof, can be used.

### Second Power Module

The second power module 19 is used for seamlessly switching power supply when the external power supply is insufficient or fails, avoiding the disappearance of light effects and interruption of audio playback. In this embodiment, the second power module 19 can use rechargeable batteries.

### String Light

The string light 20 is mainly used for creating atmosphere and enhancing visual effects, and for scene decoration to enhance the immersion of the festival. In this embodiment, the string light 20 is model 3528, including positive and negative terminals. In some embodiments, the string light 20 can also use models 5050, 2835, 3014, or 5630, as well as smart Bluetooth/Wi-Fi, color string lights, programmable string lights, waterproof string lights, electronic candles, starry sky projection lights, LED string lights, RGB string lights, etc., but is not limited to these.

### Mounting Structure

The mounting structure 33 is installed on the object to be decorated. The mounting structure 33 includes a second connection portion 34 and a second port 39. The second port 39 is selectively electrically connected to the first port 24. The first connection portion 28 is detachably connected to the second connection portion 34 to allow the decoration 27 to be detachably connected to the mounting structure 33. The first port 24 is fixed to the first connection portion 28, and the second port 39 is fixed to the second connection portion 34 and corresponds to the first port 24. When the decoration 27 is installed on the mounting structure 33 through the first connection portion 28 and the second connection portion 34, the first port 24 is electrically connected to the second port 39.

### Decoration

The decoration 27 is the core component of festival decoration, creating an immersive festival atmosphere through the combination of sound effects, light effects, and dynamic effects. The decoration 27 includes a first connection portion 28.

As shown in FIGS. 5-10, in this embodiment, the decoration 27 includes Santa Claus, 3D reindeer, cartoon reindeer, snowmen, Christmas trees, gift boxes, candy cane lights, pumpkin lights, ghosts, bats, skeletons, black cats, etc. These decorations 27 have matching dynamic light effects, sound effects, and dynamic effects. The mounting structure 33 is installed on the object to be decorated, the decoration 27 is detachably connected to the mounting structure 33, and the slave-controlling device 12 is fixed to the decoration 27.

As shown in FIGS. 8-9, in this embodiment, the slave-controlling device 12 is connected to the host-controlling device 2 through a wire 26.

As shown in FIG. 10, in some embodiments, the slave-controlling device 12 is connected to the host-controlling device 2 wirelessly.

### Sensor

The sensor 40 is mainly used for detecting biological activity and transmitting the detected information to the host-controlling device 2. The sensor 40 is electrically connected to the host-controlling device 2. For example, when a human enters the detection range of sensor 40, sensor 40 generates first information based on the detected signal and sends it to the host controller 3 of the host-controlling device 2 so that the host controller 2 triggers light effects and/or plays voice or music based on the first information.

In this embodiment, sensor 40 is installed on decoration 27 to enhance the interaction between decoration 27 and biological entities (such as humans).

### User Interface

The user interface 41 is mainly used for user input and status display.

In this embodiment, the user interface 41 includes a touch screen, and users can manage devices (add, delete, group), manage audio files (upload, delete, play), control playback (play, pause, volume adjustment), and display status (battery level, playback progress) through the touch screen.

### Voice Identification Module

The voice identification module 42 is mainly used for interacting with voice commands. In some embodiments, the voice identification module 42 uses the LD3320 offline voice recognition module. The LD3320 is a single-chip module that supports offline non-specific voice recognition, can dynamically edit up to 50 keywords, does not require networking or user voice training, has a recognition response time of ≤500 ms, and an accuracy rate of ≥95% in a quiet environment.

### Button

The button 43 is configured to control the host controller 3 to output signals of different states. Short press, long press, double-click, and release of button 43 correspond to different signals so that the host controller 3 generates different control instructions. Among these, different control instructions correspond to different light modes and audio playback.

### Remote Controller

The remote controller 44 is used to remotely control the sound and light effects of the holiday decorations through wireless signals (such as infrared, Bluetooth, RF, microwave, or Wi-Fi), supporting functions such as play, pause, volume adjustment, and light effect switching.

In this embodiment, the remote controller 44 uses a low-power Bluetooth remote controller (such as the nRF52832 remote controller), which has strong compatibility, low power consumption, and is easy to integrate with mobile phone apps. In some embodiments, the remote controller 44 can use infrared remote controllers (infrared emission modules based on the NEC protocol) or Wi-Fi remote controllers (based on ESP32).

### Smart Device

The smart device 45 is used to receive instructions input by the user and transmit these instructions to the host controller 3.

In this embodiment, the smart device 45 includes mobile phones, computers, etc.

The connection structure of the decorative device 1 will be introduced below in conjunction with FIGS. 11-15.

In this embodiment, as shown in FIG. 11, the detachable connection is achieved by plugging, and the first connection portion 28 and the second connection portion 34 are a plug 29 and a slot 35, respectively.

In one embodiment, as shown in FIG. 12, the detachable connection is achieved by hanging, and the first connection portion 28 and the second connection portion 34 are a hanging hole 30 and a rope 36, respectively.

In another embodiment, as shown in FIG. 13, the detachable connection is achieved by magnetic attraction, and the first connection portion 28 and the second connection portion 34 are a first magnet 31 and a second magnet 37, respectively.

In another embodiment, as shown in FIG. 14, the detachable connection is achieved by threading, and the first connection portion 28 and the second connection portion 34 are a threaded column 32 and a threaded hole 38, respectively.

In another embodiment, as shown in FIG. 15, the detachable connection is achieved by threading, and the first connection portion (not shown in the figure) and the second connection portion 34 are a threaded column (not shown in the figure) and a threaded hole 38, respectively.

In this embodiment, the host-controlling device 2 also includes a third port, which is electrically connected to the second port 39. As shown in FIG. 13, the first port 24 and the second port 39 are a contact 25 and a contact plate 46, respectively, and the contact 25 is selectively electrically connected to the contact plate 46.

This application also provides a control circuit for the decorative device. Please refer to FIG. 16 for the circuit structure of the decorative device 1. Decorative device 1 includes:

### Host Controller

The host controller 3 is selectively electrically connected to the microcontroller 13, meaning multiple connection states exist between the host controller 3 and the microcontroller 13. Among these, when the decoration 27 and the mounting structure 33 are in a separated state, the host controller 3 and the microcontroller 13 are in a disconnected state without power. When the decoration 27 and the mounting structure 33 are in a connected state, the host controller 3 and the microcontroller 13 are in an electrically connected state.

In this embodiment, the chip model of the host controller 3 is FMD FT61XX, and the host controller 3 includes 14 pins numbered 1˜14. In some embodiments, the host controller 3 is a smartphone, with all sound and light effects of the holiday decorations being controlled through an app installed on the phone, achieving dynamic matching of sound effects, light effects, and dynamic effects. In some embodiments, the host controller 3 is a Zigbee coordinator, such as CC2530, offering high synchronization accuracy and anti-interference capabilities. In other embodiments, the host controller 3 is a DMX controller, such as ENTTEC USB Pro, suitable for professional scenarios with stable and reliable performance.

In this embodiment, pin 1 of the host controller 3 is electrically connected to pin 2 of the RF receiving module 9, pins 2 and 3 of the host controller 3 are electrically connected to pins 3 and 2 of the WIFI module 10, respectively, pin 4 of the host controller 3 is connected to the positive power supply, pin 8 of the host controller 3 is electrically connected to pin 7 of the microcontroller 13, pin 9 of the host controller 3 is electrically connected to pin 6 of the microcontroller 13, pin 11 of the host controller 3 is grounded, pin 12 of the host controller 3 is electrically connected to one end of the protection resistor 21, pin 13 of the host controller 3 is electrically connected to pin 2 of the sensor 40, and pin 14 of the host controller 3 is electrically connected to one terminal of the button 43.

The host controller 3 sends a first control signal to the string light 20 through pin 12. The first control signal from pin 12 is transmitted to the base of the NPN transistor 22 through the protection resistor 21. When the base of the NPN transistor 22 receives the first control signal, the NPN transistor 22 turns on or off based on the first control signal, thereby controlling the LED string light 23 to emit light.

In this embodiment, the duty cycle of the first control signal in each period corresponds to the beat of each part of the pre-stored music, allowing the LED string light 23 to emit light according to the beat of the pre-stored music. That is, the LED string light 23 can emit light according to the beat of the pre-stored music without external drivers (such as a microphone), offering the advantage of low cost.

### Microcontroller

Microcontroller 13 is used for generating a second control signal.

In this embodiment, the chip model of the microcontroller 13 is EV3P087J, and the microcontroller 13 includes 8 pins numbered 1˜8. In some embodiments, the chip model of the microcontroller 13 is the ESP32-WROOM module, which supports both Wi-Fi and Bluetooth functions, facilitating the integration of data processing, control, and communication functions. In some embodiments, the microcontroller 13 can also use Arduino Nano 33 IoT processors, Raspberry Pi Pico processors, nRF52840 processors, STM32 processors, etc., but is not limited to these. In some embodiments, the microcontroller 13 does not have communication functions, in which case the microcontroller 13 also includes a second communication module 15, which can use modules such as ESP32, ESP8266, nRF52840, or Zigbee.

### First Port

The first port 24 is mainly used for powering the slave-controlling device 12 and integrating charging and power supply. In some embodiments, the first port 24 is a contact. In some embodiments, the first port 24 can also use Type-C PD ports, Micro USB ports, DC 5.5×2.1 mm ports, XT30 ports, etc., but is not limited to these.

In this embodiment, pins 2 and 3 of microcontroller 13 are electrically connected to the positive and negative terminals of the speaker 17, respectively; pin 4 of the microcontroller 13 is connected to the positive power supply and grounded through the capacitor 47, pin 5 of the microcontroller 13 is grounded, and pins 6 and 7 of the microcontroller 13 are electrically connected to pins 9 and 8 of the host controller 3 respectively.

### Sensor

The sensor 40 is electrically connected to the host controller 3 and is used for outputting the first information to the host controller 3. When the host controller 3 is electrically connected to the microcontroller 13, the host controller 3 controls the speaker 17 to produce sound and/or the string light 20 to emit light based on the first information.

In this embodiment, the chip model of sensor 40 is RCWL-0517, and the sensor 40 includes 3 pins numbered 1˜3. Pin 1 is grounded, pin 2 is electrically connected to pin 13 of the microcontroller 13, and pin 3 is connected to the positive power supply. In some embodiments, the chip model of sensor 40 is the HC-SR501 infrared human sensor. In some embodiments, the sensor 40 can also use microwave radar sensors such as LD2410B, TOF gesture sensors such as VL53L1X, piezoelectric film sensors such as FlexiForce A401, etc., but is not limited to these.

When sensor 40 detects biological activity, pin 2 outputs the first information to pin 13 of the host controller 3. When the host controller 3 receives the first information, the host controller 3 outputs an enable signal through pin 9 and outputs the first control signal through pin 12. When pin 6 of the microcontroller 13 receives the enable signal, the microcontroller 13 controls the speaker 17 to play the pre-stored audio stored in the microcontroller 13. When pin 7 of the microcontroller 13 receives an adjustment signal from pin 8 of the host controller 3, the microcontroller 13 adjusts the volume of the speaker 17 based on the adjustment signal.

### String Light

In this embodiment, the string light 20 is electrically connected to the host controller 3, and the host controller 3 controls the string light 20 to emit light.

In some embodiments, the string light 20 is electrically connected to the microcontroller 13, and the microcontroller 13 controls the string light 20 to emit light.

The string light 20 includes the protection resistor 21, the NPN transistor 22, and the LED string light 23. One end of the protection resistor 21 is electrically connected to pin 12 of the host controller 3, and the other end is connected to the base of the NPN transistor 22. The collector of the NPN transistor 22 is connected to the negative terminal of the LED string light 23, and the emitter is grounded. The positive terminal of the LED string light 23 is connected to an external power supply to receive the positive power supply.

In this embodiment, the string light 20 is directly connected to the host controller 3, with the specific connection method as follows:

The string light 20 is electrically connected to the host controller 3, and the host controller 3 controls the string light 20 to emit light. The host controller 3 outputs a first control signal to the microcontroller 13 and a second control signal to the string light 20 in response to the first information. The microcontroller 13 outputs a third control signal to speaker 17 in response to the first control signal. The speaker 17 produces sound in response to the third control signal, and the string light 20 emits light in response to the second control signal.

In some embodiments, the string light 20 is indirectly connected to the host controller 3, with the specific connection method as follows:

The string light 20 is electrically connected to the microcontroller 13, and the host controller 3 controls the microcontroller 13, which in turn controls the string light 20 to emit light. The host controller 3 outputs a first control signal and a second control signal to the microcontroller 13 in response to the first information. The microcontroller 13 outputs a fourth control signal and a fifth control signal to the speaker 17 and the string light 20, respectively, in response to the first control signal. Speaker 17 produces sound in response to the fourth control signal, and string light 20 emits light in response to the fifth control signal.

In some embodiments, the third control signal and the fourth control signal are also used for controlling the volume of the speaker 17.

### Button

The button 43 is electrically connected to the host controller 3. The button 43 includes two terminals, with one terminal electrically connected to pin 14 of the host controller 3 and the other terminal grounded.

### Microphone

In some embodiments, the microphone 18 is electrically connected to the microcontroller 13 and is used for outputting second information to the microcontroller 13. Microcontroller 13 outputs a sixth control signal in response to the second information, and the string light 20 emits light in response to the sixth control signal.

### Speaker

The speaker 17 is electrically connected to the microcontroller 13. The positive and negative terminals of speaker 17 are electrically connected to pins 2 and 3 of the microcontroller 13, respectively.

### RF Receiving Module

The RF receiving module 9 is electrically connected to the microcontroller 13. The RF receiving module 9 includes 3 pins numbered 1˜3. Pin 1 is grounded, pin 2 is electrically connected to pin 1 of the microcontroller 13, and pin 3 is connected to the positive power supply.

In this embodiment, the RF receiving module 9 and the remote controller 44 are connected wirelessly, used for responding to user operations on the remote controller 44 and receiving signals from the remote controller 44.

### WIFI Module

The WIFI module 10 is electrically connected to the microcontroller 13. The WIFI module 10 includes 3 pins numbered 1˜4. Pin 1 is grounded, pin 2 is electrically connected to pin 3 of the host controller 3, pin 3 is electrically connected to pin 2 of the host controller 3, and pin 4 is connected to the positive power supply.

In this embodiment, the WIFI module 10 and the smart device 45 are connected wirelessly, used for receiving signals from the smart device 45.

### User Interface

In some embodiments, the host-controlling device 2 also includes a user interface 41, which is electrically connected to the host controller 3.

### Voice Identification Module

In some embodiments, the control circuit also includes a voice identification module 42, which is electrically connected to the microcontroller 13.

### Control Method of the Decorative Device

This application also provides a control method for decorative device 1, which is applied to the decorative device 1 described in the above embodiments. Please refer to FIG. 17. The execution entity of the control method of the decorative device 1 is the host controller 3. The method includes the following steps:

Step 1701. Obtaining first information.

The first information is obtained based on real-time detection of biological activity by the sensor 40. For example, when sensor 40 (such as an infrared sensor, radar sensor, or camera) detects human activity within its sensing range, sensor 40 outputs the first information and transmits it to the host controller 3. The sensor 40 continuously detects human activity in the target area. If it detects that the human has left the target area, the microcontroller 13 controls the string light 20 and the speaker 17 to turn off.

In some embodiments, the first information detected by the sensor 40 is directly transmitted to the microcontroller 13, enabling the microcontroller 13 to directly control the string light 20 and the speaker 17.

In some embodiments, the first information includes identification information of the sensor 40.

In some embodiments, the first information also includes identification information of the target slave-controlling device 12.

In some embodiments, the identification information of the target slave-controlling device 12 includes the ID, serial number, or MAC address of the target slave-controlling device 12. For example, users can input the unique identifier (such as device ID, serial number, or MAC address) of the target slave-controlling device 12 through manual input, scanning (such as QR code/NFC tag), or voice commands.

Step 1702. Controlling the speaker 17 to produce sound and/or the string light 20 to emit light based on the first information.

In some embodiments, the host controller 3 receives the first information and sends a first control signal to the microcontroller 13 based on the first information, causing the microcontroller 13 to output a third control signal to the speaker 17 in response to the first control signal. The third control signal is used to trigger speaker 17 to produce sound.

In some embodiments, the host controller 3 receives the first information and outputs a second control signal to the string light 20 based on the first information. The second control signal is used to trigger the string light 20 to emit light.

In some embodiments, the host controller 3 receives the first information and sends a first control signal and a second control signal to the microcontroller 13 based on the first information, causing the microcontroller 13 to output a fourth control signal and a fifth control signal to the speaker 17 and the string light 20 respectively in response to the first control signal. Speaker 17 produces sound in response to the fourth control signal, and string light 20 emits light in response to the fifth control signal, achieving the effect of simultaneous operation of speaker 17 and string light 20.

In some embodiments, the host controller 3 identifies the location information of sensor 40 based on the identification information of sensor 40 and controls the string light 20 to emit light based on the light mode corresponding to the location information and/or controls the speaker 17 to produce sound based on the audio information corresponding to the location information.

In some embodiments, after obtaining the identification information of the target slave-controlling device 12, the host controller 3 controls the string light 20 to emit light based on the light mode corresponding to the identification information of the target slave-controlling device 12 and/or controls the speaker 17 to produce sound based on the audio information corresponding to the identification information of the target slave-controlling device 12.

### Another Control Method of the Decorative Device

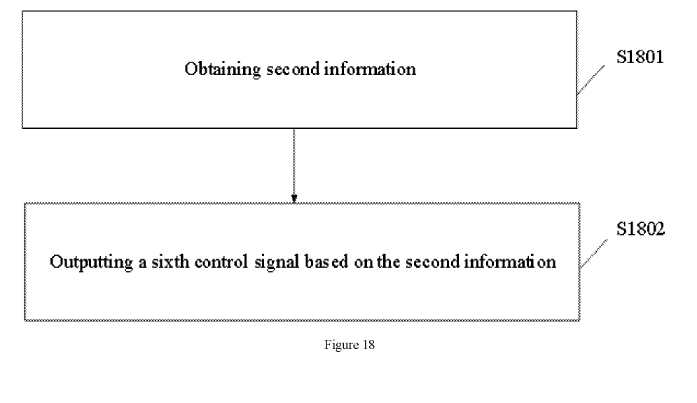

This application also provides another control method for decorative device 1, which is applied to the decorative device 1 described in the above embodiments. Please refer to FIG. 18. The execution entity of the control method of the decorative device 1 is the microcontroller 13. The method includes the following steps:

Step 1801. Obtaining second information.

The second information is generated by the microcontroller 13 based on the audio signal detected in real-time by the microphone 18.

In this embodiment, the second information includes the audio information detected by the microphone 18.

Step 1802. Outputting a sixth control signal based on the second information. The sixth control signal is used to trigger the string light 20 to emit light.

In some embodiments, the microcontroller 13 determines the light mode of the string light 20 corresponding to the audio information based on the audio information detected by the microphone 18.

In some embodiments, after obtaining the second information and triggering the string light 20 to emit light, the microcontroller 13 sends a seventh control signal to the speaker 17 to further trigger the speaker 17 to produce sound.

In some embodiments, after obtaining the second information, the microcontroller 13 sends a sixth control signal and a seventh control signal to the string light 20 and the speaker 17, respectively, simultaneously triggering the string light 20 to emit light and the speaker 17 to produce sound.

The embodiments described above are merely examples of the present disclosure, and should not be used to limit the scope of the present disclosure, which may have various modifications and variations made by specialists in the field. Any modification, equivalent replacement or improvement made within the spirits and principles of the present disclosure shall be included in the scope of protection of the present disclosure.

1. An intelligent music synchronization lighting element, comprising:
a human body sensing module configured to sense a human body and output a sensing signal when the human body is sensed;
a control module connected with the human body sensing module, the control module configured to receive the sensing signal and output an enable signal and a control signal according to the sensing signal, generate a synchronized enable signal wherein the enable signal duty cycle is modulated according to musical beat patterns, the enable signal and the control signal being outputted by different output terminals;
a music control module connected with the control module, the music control module configured to receive the enable signal and play a predetermined music according to the enable signal; and
a lighting element connected with the control module, the lighting element configured to receive the control signal and start to work according to the control signal, a duty cycle of the control signal in each cycle corresponding to beats of each section of the predetermined music, so that the flashing frequency of the lighting element, the beats of the predetermined music, and the frequency of human activity detected by the human body sensing module are synchronized.

2. The system of claim 1, wherein the sensing module comprises:
a radar-based motion detection sensor configured for real-time user movement tracking within a specified detection zone; and
a signal conditioning circuit that converts raw sensor output into the presence signal compatible with the control processing unit.

3. The system of claim 1, wherein the control processing unit comprises:
a microcontroller with onboard signal routing logic, the microcontroller configured to independently manage the activation command output and the synchronized timing signal output through dedicated output ports;
a memory module storing the musical beat pattern templates; and
logic circuitry that correlates presence signal characteristics with beat pattern intensity transitions.

4. The system of claim 1, wherein the sound generation module comprises:
a dedicated audio processor chip containing pre-recorded audio content and beat synchronization logic;
an audio transducer mechanically coupled to the audio processor chip; and
a volume control interface responsive to external adjustment signals.

5. The system of claims claim 4, further comprising:
a user input device mechanically coupled to the control processing unit, the user input device configured to transmit adjustment commands to the audio processor chip for modulating audio output level.

6. The system of claim 1, wherein the visual output module comprises:
a current-limiting resistive element;
a semiconductor switching device with control, conducting, and ground terminals;
a light-emitting diode string with positive and negative electrical connections;
wherein the control terminal of the semiconductor switching device is connected to receive the synchronized timing signal from the control processing unit, and wherein the conducting terminal is electrically connected to the negative connection of the light-emitting diode string.

7. The system of claim 1, further comprising:
a radio frequency reception module in communication with the control processing unit; and
a remote-control transmitter configured to send commands to the control processing unit via the radio frequency reception module.

8. The system of claim 1, further comprising:
a wireless communication module selected from the group consisting of: WiFi protocol implementation, Bluetooth protocol implementation, and cellular (4G/5G) protocol implementation;
wherein the wireless communication module is configured to receive operational parameters from an external networked device and transmit such parameters to the control processing unit.

9. The system of claim 1, wherein the synchronized timing signal is generated by:
analyzing the frequency and amplitude characteristics of the audio content;
identifying strong beat occurrences and weak beat occurrences within each musical measure;
assigning a first electrical voltage level to strong beat occurrences; and
assigning a second electrical voltage level distinctly different from the first voltage level to weak beat occurrences.

10. The system of claims claim 1, wherein:
the wireless communication module receives configuration instructions from a smart home control platform;
the control processing unit adjusts the beat pattern intensity and audio volume responsively to instructions received through the wireless communication module;
the visual output module dynamically adapts illumination characteristics based on integrated commands from both the presence signal and the smart home platform.

11. A method of synchronizing a lighting element with music based on human presence, comprising:
sensing, by a human body sensing module, a presence of a human body and outputting a sensing signal in response to sensing the human body;
receiving, by a control module, the sensing signal;
generating, by the control module, an enable signal and a control signal based on the sensing signal, wherein the enable signal has a duty cycle modulated according to musical beat patterns;
outputting the enable signal and the control signal through different output terminals of the control module;
receiving, by a music control module, the enable signal and playing a predetermined music in accordance with the enable signal;
receiving, by a lighting element, the control signal; and
controlling the lighting element according to the control signal to cause the lighting element to operate, wherein a duty cycle of the control signal in each cycle corresponds to beats of each section of the predetermined music such that a flashing frequency of the lighting element is synchronized with the beats of the predetermined music and a frequency of human activity detected by the human body sensing module.

12. The method of claim 11, wherein continuously monitoring comprises:
transmitting electromagnetic waves into the environmental zone;
receiving reflected electromagnetic signals;
comparing reflected signal characteristics against baseline signatures to identify motion consistent with human movement;
filtering out signal noise below a specified amplitude threshold to reduce false-positive detections.

13. The method of claim 11, wherein the audio playback sequence comprises:
retrieving stored audio content from an onboard non-volatile memory device;
alternatively, receiving streamed audio content via a network communication interface;
decoding the audio content according to industry-standard compression protocols;
outputting decoded audio to a transducer device.

14. The method of claim 11, wherein generating the control timing signal comprises:
analyzing audio frequency domain characteristics to identify dominant beat frequencies;
detecting beat occurrence times within the audio sequence;
classifying each detected beat as either a strong beat or a weak beat based on comparative amplitude analysis;
encoding strong beat classifications as high-voltage logic levels in the control timing signal;
encoding weak beat classifications as low-voltage logic levels in the control timing signal;
repeating the classification and encoding process for each beat cycle throughout the audio sequence duration.

15. The method of claim 11, wherein applying the processed control timing signal to light-emitting diodes comprises:
transmitting the processed timing signal to a base terminal of a transistor switching device;
allowing the transistor to conduct current from a power supply to a light-emitting diode string when the timing signal voltage exceeds a conduction threshold;
blocking current flow through the light-emitting diode string when the timing signal voltage falls below the conduction threshold;
thereby creating visible illumination pulses synchronized with the beat patterns.

16. The method of claim 11, further comprising:
receiving a volume adjustment input from a user control button;
transmitting the volume adjustment input to an audio processor chip;
modulating the amplitude of audio output from the transducer device in response to the volume adjustment input;
optionally adjusting the control timing signal amplitude proportionally to the audio amplitude adjustment to maintain synchronized beat perception.

17. The method of claim 11, wherein the user termination command is received by:
detecting an infrared signal transmitted from a dedicated remote control device;
decoding the infrared signal to identify a stop command;
transmitting an inhibit signal to the audio processor chip;
simultaneously removing the control timing signal from the lighting control module;
allowing previously-active light-emitting diodes to return to an off state.

18. The method of claim 11, further comprising:
receiving operational mode instructions via a wireless communication interface connected to a remote networked device;
parsing the operational mode instructions to identify requested audio content selections;
parsing the operational mode instructions to identify requested illumination intensity levels;
retrieving the requested audio content from the onboard non-volatile memory;
scaling the generated control timing signal amplitude according to the requested illumination intensity levels;
executing the audio playback and synchronized illumination according to the received instructions.

19. The method of claim 11, wherein continuously monitoring comprises:
establishing an initial sensitivity threshold for motion detection based on ambient environmental conditions;
periodically re-evaluating the sensitivity threshold based on recent signal statistics;
automatically increasing sensitivity during periods of low ambient motion to improve detection responsiveness;
automatically decreasing sensitivity during periods of high ambient motion to reduce false-positive triggering;
maintaining an adaptive detection baseline that evolves over time without requiring manual recalibration.

20. The method of claims claim 11, comprising:
operating the system in a first autonomous mode wherein human presence alone triggers synchronized audio and illumination;
operating the system in a second network-controlled mode wherein remote operational commands override autonomous presence detection;
operating the system in a third hybrid mode wherein both presence detection signals and remote network commands are evaluated conjunctively;
allowing users to transition between operating modes through either physical user input devices or networked control commands;
maintaining synchronized audio-visual output regardless of which operating mode is active.
